(19) United States
(12) Patent Application Publication
(10) Pub. No.: US 2010/0151983 A1
(43) Pub. Date: Jun. 17, 2010

(54) Spider-less vehicle differential

(76) Inventors: James F. Ziech, Kalamazoo, MI (US); Steve Slesinski, Kalamazoo, MI (US); Leo J. Wenstrup, Portage, MI (US)

Correspondence Address: MARSHALL & MELHORN, LLC, FOUR SEAGATE - EIGHTH FLOOR, TOLEDO, OH, 43604, US

(21) Appl. No.: 12/316,314

(22) Filed: Dec. 11, 2008

(51) Int. Cl. F16H 48/08

(52) U.S. Cl. 475/230; 475/246

(57) ABSTRACT

A differential case has a plurality of spaced apart recesses on an internal surface for receiving a plurality of side pinions within the recesses. The side pinions are driven by the case without a differential spider or differential pin.

### FIELD OF THE INVENTION

The present invention relates to a vehicle differential and more particularly to a vehicle differential without a spider shaft or differential pin.

### BACKGROUND OF THE INVENTION

Typical wheel differential side pinions are driven by a spider shaft, or differential pin, that requires a through bore in each side pinion. The bore creates a thin section of material at the side pinion toe end that is a potential failure mode and which limits the maximum spider shaft diameter. Further, the spider shafts are separate pieces that can be expensive to manufacture.

The side pinions and spider shaft are housed within a differential case. Prior art differential cases are often constructed from two pieces that require a first bolt circle to secure the two pieces together and a second bolt circle to secure the ring gear to the joined case pieces. Alternatively, a single bolt circle can be used to both secure the cases together and the ring gear to the joined cases. Even with a single bolt circle, however, two differential case halves must be used to allow the wheel differential gears to be assembled within the case when two or more side pinions are used. One piece differential cases are used, but they are restricted to two pinion differentials with a single cross pin and they cannot be used with three or four pinion differentials. Three or four pinion differentials require a complex differential spider or multiple cross pins to transmit the rotational energy from the differential case to the side pinions. The cross pin or spider arms necessitate a thin section at the side pinion toe end.

In addition to the components described above, heavy duty drive axles use separable differential bearing caps to allow the differential to be installed into the differential carrier housing. Machining the caps is expensive and requires that the caps be machined in place and then removed to install the differential assembly. Large bolts are needed to secure the carrier caps to the differential carrier housing, which adds to the expense.

In view of the shortcomings of the prior art differentials, it would be advantageous to avoid thinning the wheel differential side pinions to reduce or prevent potential failures in this area. It would also be advantageous to eliminate the need for a spider pin to reduce material and production costs. It would also be advantageous to utilize a simple design to facilitate installation of the differential within the differential carrier housing and to minimize cost.

### SUMMARY OF THE INVENTION

The present invention is directed toward a differential without a spider shaft or differential pin. Differential side pinions are located within side pinion recesses within the differential case. The differential case directly drives the side pinions.

### BRIEF DESCRIPTION OF THE DRAWINGS

The above, as well as other advantages of the present invention will become readily apparent to those skilled in the art from the following detailed description when considered in the light of the accompanying drawings in which:

FIG. 1 is a cut away plan view of one embodiment of the present invention;

FIG. 2 is a cutaway plan view of another embodiment of the present invention; and

FIG. 3 is a cutaway plan view of yet another embodiment of a portion the present invention.

### DETAILED DESCRIPTION OF THE PREFERRED EMBODIMENTS

It is to be understood that the invention may assume various alternative orientations and step sequences, except where expressly specified to the contrary. It is also to be understood that the specific devices and processes illustrated in the attached drawings, and described in the following specification are simply exemplary embodiments of the inventive concepts defined in the appended claims. Hence, specific dimensions, directions or other physical characteristics relating to the embodiments disclosed are not to be considered as limiting, unless the claims expressly state otherwise.

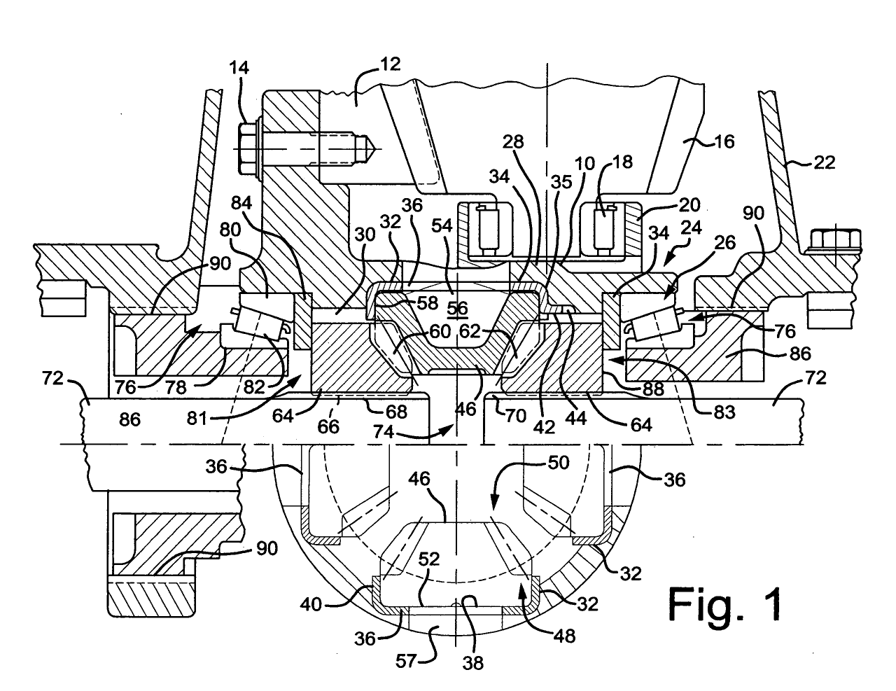

Turning now to FIG. 1, one embodiment of a one-piece, integrally formed and unitary differential case 10 is depicted. A ring gear 12 is secured to the differential case, such as through mechanical fasteners 14. While only one such fastener 14 is depicted, those skilled in the art will readily appreciate that additional fasteners are required to secure the ring gear 12 to the case 10.

The ring gear 12 is meshed with a pinion gear 16. The pinion gear 16 is connected to a source of rotational energy, such as a vehicle driveline comprising a prime mover. The prime mover may be such as an internal combustion engine.

The pinion gear 16 may be supported at one end by a pinion bearing 18. The pinion bearing 18 may be supported with a bearing cage 20 that is attached to a differential housing 22.

The differential case 10 has an outer surface 24, an inner surface 26 and wall 28 between the surfaces 24, 26. The inner surface 26 defines a hollow cavity 30 within the case 10.

Two or more spaced-apart recesses 32 are integrally formed into the inner surface 26. The recesses 32 each terminate in a recess base 34, which is surrounded by a wall 35. In other words, the recesses 32 are directed radially outward into the case 10. The number of recesses 32 can be two, three, four or more. The recesses 32 are circumferentially located about the inner surface 26 and equally spaced about the same.

A side pinion cup 36 may be located within each recess 32. The side pinion cup 36 has a base 38 and side walls 40 surrounding the base 38. The side walls 40 are angled with respect to the base 38, such as perpendicular to the base 38.

One or more tabs 42 preferably extend from the side wall 40 at an angle. The angle may be such as substantially perpendicular or otherwise. The tabs 42 may be circumferentially spaced apart about the side wall 40 or they may be at any distance away from one another.

The tabs 42 extend into slots 44 spaced about the recesses 32 in the differential case 10. The slots 44 have a complimentary shape, size and angle to the tabs 42. The tabs 42 prevent relative rotation of the cups 36 with respect to the differential case 10.

The side pinion cups 36 prevent, or reduce, the side pinions from wearing the surfaces 34, 35 of the recess 32, thus extending the life of the differential case 10.

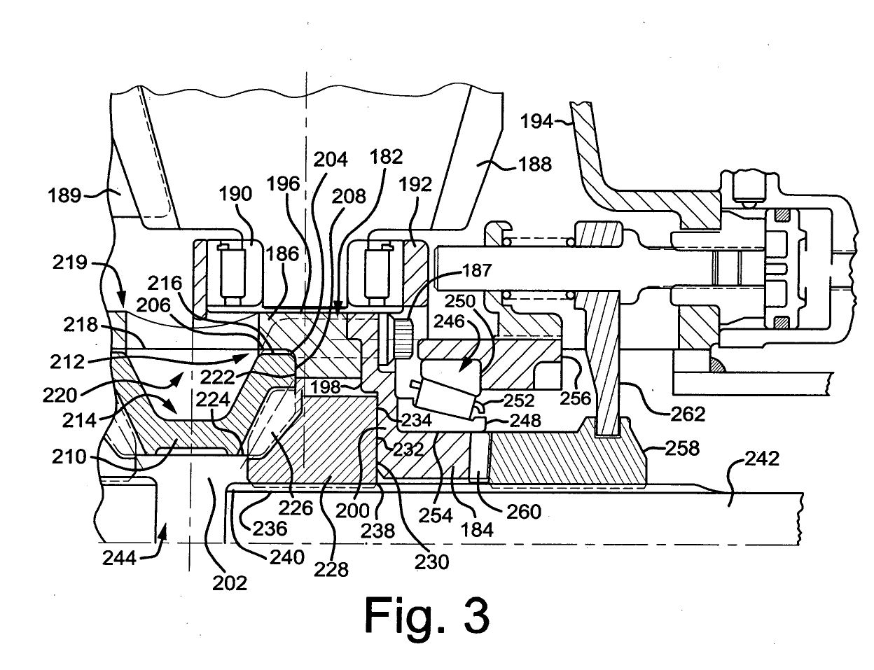

Alternatively or additionally, the surfaces 34, 35 of the recesses 32 may be hardened by heat treating to reduce or prevent the side pinions from creating wear on the surfaces of the recesses 32. One method of heat treating, which the present invention is not limited to, is laser heat treating. Where the recess surfaces 34, 35 have been heat treat hardened, the side pinions cups 36 and tabs 42 with corresponding slots 44 may not be required (see FIG. 3).

Side pinions 46 are located within each of the cups 36. Each side pinion 46 has a heel end 48 that fits within a cup 36 and a toe end 50. The heel end 48 directly contacts the side pinion cup base 38, or the base 34 of the recess 32, as the case may be. The heel end 48 is large enough to stabilize the side pinions 46 within the cup 36 or recess 32 so that the side pinions 46 need no support at their toe ends 50. The base 34 and walls 35 of the recesses 32 directly drive the side pinions 46, or the cups 36 and thus the pinions 46, with no intervening structure.

Preferably, each heel end 48 defines a substantially flat surface 52 around an opening 54. A radially inward directed lubricant reservoir 56 extends from the opening 54 toward the toe end 50. The toe end 50 closes the reservoir 56. The reservoir 56 holds differential lubricant, which assists in lubricating the pinion 46, particularly when a pinion 46 reaches an uppermost position during differential rotation. Additionally, an opening 57 in the differential case 10 allows direct splash lubrication to surfaces 38, 52 and 58.

The heel end 48 of each side pinion 46 has a complimentary shape to the side pinion cup 36. This includes an upstanding wall 58 located about the flat heel end 48 of the side pinion 46. The upstanding wall 58 has a cylindrical shape. A plurality of teeth 60 is located on a radially directed inward portion of the upstanding wall 58.

The side pinion 60 teeth mesh with a plurality of teeth 62 on side gears 64, also located within the differential case 10. The side gears 64 may be of any shape or design and are not limited to the shape and design depicted in the figures.

The side gears 64 are hollow and a plurality of teeth 66 are located on an inside surface 68 of each side gear 64. The inside surface teeth 66 mesh with splines 70 on an outside diameter of axle half shafts 72 for imparting rotational drive to the axle half shafts 72.

Based on the above, it can be appreciated that no spider shaft connecting the side pinions 46 to the ring gear 12 or the differential case 10 is required. Instead, the side pinions 42 and axle half shafts 72 define a hollow gap 74 between them.

In a preferred embodiment, a differential bearing system 76 comprising an inner race 78, an outer race 80 and a roller bearing 82 is provided to facilitate differential rotation within the differential housing 22. The differential bearing system 76 is preferably press fit into place after the side pinions 46 and side gears 64 are located inside of the differential case 10. The open sides 81, 83 of the differential case 10 make installation of the side pinions 46 and the two side gears 64 into the case 10 relatively easy.

The differential bearing system 76 is located outboard of a thrust washer 84 and between the inner surface 26 of the differential case 10 and a bearing adjuster 86. The thrust washer 84 may abut one of the races 78, 80 of the differential bearing system 76 and an outboard surface 88 of a side gear 64. More specifically, the thrust washer 84 may abut the outer race 80 that is located directly radially inward from the inner surface 26 of the differential case 10.

Based on the foregoing, it can be appreciated that the thrust washers 84 effectively form differential case end closures as they are trapped in place by the press-fit differential bearing system 76. In this position, the thrust washers 84 react against the side gear thrust forces during operation of the differential.

The bearing adjuster 86 may be engaged with a full thread or a thread and a pilot diameter to the inner surface 90 of the differential housing 22. The bearing adjuster 86 may be threaded in or out of the housing 22 so as to allow installation of the differential case 10 with the ring gear 12, thrust washers 84, etc, into the housing 22 and to adjust the preload on the differential bearing system 76. A lock mechanism (not shown) may be used to secure the adjuster 86 in place. Inner surface 90 is a continuous 360 degree surface in the housing 22 and it is cylindrical in shape, therefore, no separate bearing cap is required.

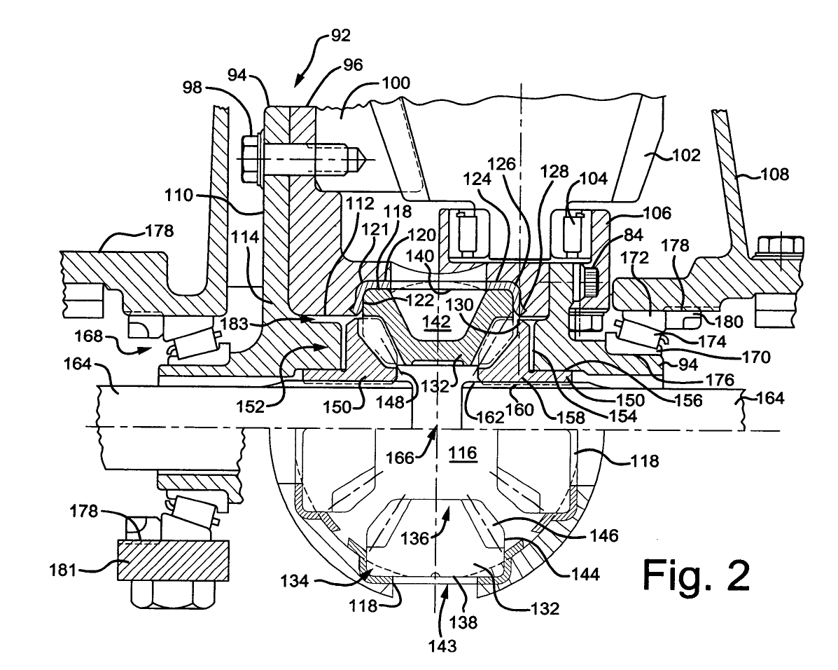

Turning now to FIG. 2, another embodiment of the present invention is depicted. In this embodiment, a differential case 92 comprises a first differential case half 94 and a second differential case half 96. The case halves 94, 96 are secured together by a plurality of mechanical fasteners 98, such as bolts, one of which can be seen in FIG. 2.

A ring gear 100 is secured to the differential case 92. In the depicted embodiment, the ring gear 100 is secured to the differential case 92 with the same mechanical fasteners 98 used to secure the case halves 94, 96 together, which results in a single bolt ring. Alternatively, the ring gear 100 can be separately secured to the differential case 92.

The ring gear 100 is meshed with a pinion gear 102. The pinion gear 102 is connected to a source of rotational energy, such as a vehicle driveline comprising a prime mover. The prime mover may be such as an internal combustion engine.

The pinion gear 102 may be supported at one end by a pinion bearing 104. The pinion bearing 104 may be supported with a bearing cage 106 that is attached to a differential housing.

The differential case 92 has an outer surface 110, an inner surface 112 and wall 114 between the surfaces 110, 112. The inner surface 112 defines a hollow cavity 116 within the case 92.

Two or more spaced-apart recesses 118 are integrally formed into the inner surface 112. In other words, the recesses 118 are directed radially outward into the case 92. The recesses 118 each terminate in a recess base 120, which is surrounded by a wall 121. The number of recesses 118 can be two, three, four or more. The recesses 118 are circumferentially located about the inner surface 112 and equally spaced about the same.

A side pinion cup 122 is preferably located within each recess 118. The side pinion cup 122 has a base 124 and side walls 126 surrounding the base 124. The side walls 126 are angled with respect to the base 124, such as perpendicular to the base 124.

One or more tabs 128 preferably extend from the side wall 126 at an angle. The tabs 128 may be circumferentially spaced apart about the side wall 126 or they may be at any distance away from one another.

The tabs 128 extend into slots 130 spaced about the recesses 118 in the differential case 92. The slots 130 have a complimentary shape, size and angle to the tabs 128. The tabs 128 prevent relative rotation of the cups 122 with respect to the differential case 92.

The side pinion cups 122 prevent, or reduce, the side pinions from wearing the surfaces 120, 121 of the recess 118, thus extending the life of the differential case 92.

Alternatively or additionally, the recess surfaces 120, 121 may be hardened to reduce or prevent the side pinions from creating wear on the surfaces 120, 121 of the recesses 118. Where the recess surfaces 120, 121 have been hardened, the side pinions cups 122 and tabs 128 with slots 130 may not be required (see FIG. 3). Hardening may be accomplished with a laser.

Side pinions 132 are located with each of the cups 122 and have a complimentary shape to the cups 122. Each side pinion 132 has a heel end 134 that fits within the recess 118 and a toe end 136. The heel end 134 directly contacts the side pinion cup base 124, or the base 120 of the recess 118, as the case may be. The heel end 134 is large enough to stabilize the side pinions 132 so that the side pinions 132 need no support at their toe ends 136. The base 120 and walls 121 of the recesses 118 directly drive the side pinions 132, or the cups 122 and thus the pinions 132, with no intervening structure.

Preferably, each heel end 134 defines a substantially flat surface 138 around an opening 140. A radially inward directed lubricant reservoir 142 extends from the opening 140 toward the toe end 136. The toe end 136 closes the reservoir 142. The reservoirs 142 hold differential lubricant, which assists in lubricating the pinions 132, particularly when a pinion 132 reaches an uppermost position during differential rotation. Additionally an opening 143 in differential case 96 allows direct splash lubrication to surfaces 138, 152 and 158.

The heel end 134 of each side pinion 132 has a complimentary shape to the side pinion cup 122. This includes an upstanding wall 144 located about the flat surface 138 of the side pinions 132. The upstanding wall 144 has a cylindrical shape. A plurality of teeth 146 is located on a radially directed inward portion of the upstanding wall 144.

The side pinion teeth 146 mesh with a plurality of teeth 148 on side gears 150, also located within the differential case 92.

In this embodiment, the side gears 150 have backside surfaces 152 with a complimentary shape to an L-shaped inner surface 112 of the first and second differential case halves 94, 96. The L-shape of the backside surfaces 152 of the side gears 150 is comprised of a substantially vertical surface 154 extending approximately the length of the teeth 148. A substantially cylindrical surface 156 intersects with the vertical surface 154 to create the L-shape. Other shapes of side gears 150 are within scope of the present invention. By way of example only, see FIGS. 1 and 3.

The side gears 150 have an inner surface 158 with a plurality of teeth 160. The side gear teeth 160 mesh with splines 162 on the outer diameter of two axle half shafts 164 located within the side gears 150. Rotational force is transmitted through the side gears 150 to the axle half shafts 164 to rotate the shafts 164.

Based on the above, it can be appreciated that no spider shaft connecting the side pinions 132 to the ring gear 100 or the differential case 92 is required. Instead, the side pinions 132 and axle half shafts 164 define a hollow gap 166 between them.

In a preferred embodiment, a differential bearing system 168 comprising an inner race 170, an outer race 172 and a roller bearing 174 is provided to facilitate differential rotation within the differential housing 108. The system 168 is located between an outer surface 176 of the first differential case half 94 and an inner surface 178 of the differential housing 108. More specifically, the outer race 172 contacts the inner surface 178 of the differential housing 108 and the inner race 170 contacts the outer surface 110 of the first differential case half 94.

A bearing adjuster 180 may be located outboard, but in contact with, the outer race 172 of the bearing system 168. The bearing adjuster 180 may be threadably engaged with the inner surface 178 to adjust the preload on the bearing system 168. A lock mechanism (not shown) may be used to secure the adjuster 180 in place. Inner surface 178 is split such that one half is in the differential housing 108 and the other half is in the differential bearing cap 181.

The installation of the side gears 150 and the side pinions 132, particularly when there are more than 2 of side pinions 132, within the differential case 92 is relatively easy with the construction identified above. Namely, the gears 150 and pinions 132 can be located within the second differential case 96 and assembled through opening 183, and then the first differential case 94 can be secured to the second differential case 96. Next, differential assembly made up of cases 94, 96, ring gear 100, etc. can be assembled into housing 108, secured with the bearing cap 181 and the the differential bearing system 168 can be installed and the preload on the system 168 can be adjusted by the subsequently installed bearing adjuster 180. This same method of installation can be used for the embodiment depicted in FIG. 3.

Turning now to FIG. 3, yet another embodiment of the present invention is depicted. As in FIG. 2, this embodiment features a differential case 182 comprised of a first differential case half 184 and a second differential case half 186. The case halves 184, 186 are secured together by a plurality of mechanical fasteners, such as 187.

A ring gear 189, a portion of which is depicted, is secured to the differential case 182. The ring gear is meshed with a pinion gear 188, a portion of which is depicted in FIG. 3. The pinion gear 188 is connected to a source of rotational energy, such as a vehicle driveline comprising a prime mover. The prime mover may be such as an internal combustion engine.

The pinion gear 188 may be supported at one end by a pinion bearing 190. The pinion bearing 190 may be supported with a bearing cage 192 that is attached to a differential housing 194.

The differential case 182 has an outer surface 196, an inner surface 198 and wall 200 between the surfaces 196, 198. The inner surface 198, created by the two case halves 184, 186, defines a hollow cavity 202 within the case 182.

Two or more spaced-apart recesses 204 are integrally formed into the inner surface 198. In other words, the recesses 204 are directed radially outward into the case 182. The recesses 204 terminate in a recess base 206, which is surrounded by a wall 208. The number of recesses 204 can be two, three or four. The recesses 204 are circumferentially located about the inner surface 198 and equally spaced about the same.

In this embodiment, at least part of the side pinion recess 204 is heat treat hardened. Preferably, both the base 206 and the side wall 208 of each recess 204 are heat treat hardened. The hardening reduces, or prevents, the side pinions (discussed below) from creating wear on the side wall 208 and/or base 206 of the recesses 204. Heat treating may be accomplished by a laser.

Side pinions 210 are located within each of the recesses 204. Each side pinion 210 has a heel end 212 that fits within the recess 204 and a toe end 214. The heel end 212 directly contacts the base 206 of the recess 204. The heel end 212 is large enough to stabilize the side pinions 210 so that the side pinions 210 need no support at their toe ends 214. The base 206 and walls 208 of the recesses 204 directly drive the side pinions 210 with no intervening structure.

Preferably, each heel end 212 defines a substantially flat surface 216 around an opening 218. A radially inward directed lubricant reservoir 220 extends from the opening 218 toward the toe end 214. The toe end 214 closes the reservoir 220. The reservoirs 220 hold differential lubricant, which assists in lubricating the pinions 210, particularly when a pinion 210 reaches an uppermost position during differential rotation. Additionally, an opening 219 in the differential case 186 allows direct splash lubrication to surfaces 206, 208, 218 and 222.

The heel end 212 of each side pinion 210 has a complimentary shape to the recess 204. The flat heel end surface 216 is parallel to and in contact with the recess base 206. Additionally, the side pinion 210 has a cylindrical wall 222 that is parallel to and at least in partial contact with the recess wall 208. A plurality of teeth 224 is located on a radially directed inward portion of the wall 222.

The side pinion teeth 224 mesh with a plurality of teeth 226 on side gears 228, also located within the differential case 182.

The side gears 228 have backside surfaces 230 with a complimentary shape to the inner surface 232 of at least the first differential case half 184. The backside surface 230 may be such as a substantially vertical surface 234 extending approximately the length of the teeth 226. Other shapes of side gears 228 are within scope of the present invention. For example, see FIGS. 1 and 2.

The side gears 228 have an inner surface 236 with a plurality of teeth 238. The side gear teeth 238 mesh with splines 240 on the outer diameter of two axle half shafts 242 located within the side gears 228. Rotational force is transmitted through the side gears 228 to the axle half shafts 242 to rotate the shafts 242.

Based on the above, it can be appreciated that no spider shaft connecting the side pinions 210 to the ring gear or the differential case 182 is required. Instead, the side pinions 210 and axle half shafts 242 define a hollow gap 244 between them.

In a preferred embodiment, a differential bearing system 246, comprising an inner race 248, an outer race 250 and a roller bearing 252, is provided to facilitate differential rotation within the differential case 182. The system 246 is located between an outer surface 254 of the first differential case half 184 and a bearing adjuster 256. The bearing adjuster 256 may be threadably engaged with a component of the differential housing 194 to adjust the preload on the bearing system 246. A lock mechanism (not shown) may be used to secure the adjuster 256 in place.

In the depicted embodiment, a clutch gear 258 is splined to one of the axle half shafts 242. The gear 258 is drivingly connected to a plurality of teeth 260 on the outer surface 254 of the first differential case half 184. A shift fork 262 is connected to the clutch gear 258 to move it into and out of engagement with the first differential case half 184.

The installation of the side gears 228 and the side pinions 210, particularly when there are more than 2 pinions 210, within the differential case 182 is relatively easy with the construction identified above. Namely, the gears 228 and pinions 210 can be located within the second differential case 182, then the first differential case 184 can be secured to the second differential case 182. Next, the differential system comprising the cases 184, 186, ring gear 200, etc can be assembled into housing 194 and the differential bearing system 246 can be installed and the preload on the system 246 can be adjusted by the subsequently installed bearing adjuster 256.

In accordance with the provisions of the patent statutes, the present invention has been described in what is considered to represent its preferred embodiments. However, it should be noted that the invention can be practiced otherwise than as specifically illustrated and described without departing from its spirit or scope.

What is claimed is:

1. A differential, comprising:
a unitary differential case having an outer surface, an inner surface and a wall between said surfaces, said inner surface defining a hollow cavity within said case, wherein two or more spaced-apart recesses are unitary within said inner surface;
two or more side pinions, each side pinion having a heel end and a toe end, said heel ends opening to a radially inward directed lubricant reservoir closed by said toe end, wherein said side pinions are located within said recesses; and
at least two side gears located within said differential case and meshed with said pinion gears; and
a side pinion cup located between each of said side pinions and said differential case, each of said cups being tabbed to said differential case to prevent relative rotation.

2. The differential of claim 1, wherein said side pinions comprises three or more.

3. The differential of claim 1, wherein said recesses are circumferentially and equidistant spaced apart from one another on said inner surface.

4. The differential of claim 3, wherein said recesses are radially outward directed within said case.

5. The differential of claim 1, wherein said case has at least one slot for receiving at least one tab from at least one of said cups to secure said cup to said case.

6. The differential of claim 5, wherein said tabs are spaced apart about an outer surface of said cups.

7. The differential of claim 5, wherein said tabs are angled with respect to said outer surface of said cups.

8. The differential of claim 1, wherein said side pinions each have a cylindrical side surface and a flat heel end.

9. The differential of claim 1, wherein a thrust washer is located in said differential case between each side gear and a differential bearing race, said thrust washer encloses said side gears in said differential case.

10. The differential of claim 1, wherein a thrust washer abuts an outer differential bearing race located directly radially inward from said inner surface of said differential case.

11. The differential of claim 1, wherein a differential bearing system, comprising an inner race, an outer race and a bearing, is located outboard of a thrust washer contacting said side gear and between said inner surface of said differential case and a bearing adjuster.

12. A differential, comprising:
a first differential case half and a second differential case half, said differential case halves secured together;
two or more side pinion recesses located within an inner surface of said first differential case half;
a side pinion located within each of said side pinion recesses, each side pinion having a toe end and a heel end, said heel end opening to a radially inward directed lubricant reservoir closed by said toe end;
a side gear meshed with each of said side pinions within said first and said second differential case half.

13. The differential case of claim 12, further comprising a side pinion cup located within each of said recesses between each of said side pinions and said differential case, each of said cups fixedly tabbed to one of said differential case halves.

14. The differential of claim 12, wherein said side gears are directly adjacent an inner wall of said first differential case.

15. The differential of claim 12, wherein said side pinions are in direct contact with hardened surfaces of said recesses.

16. The differential of claim 12, wherein differential bearings are located between an outside surface of said first differential case half and a differential housing.

17. The differential of claim 12, further comprising a differential bearing system having an inner race, an outer race and a bearing, wherein said inner race is in contact with said outer surface of said differential case and said outer race is in contact with a bearing adjuster, said case separating said inner race and said side gear.

18. The differential of claim 12, wherein each of said side pinions comprises said heel end and a cylindrical side surface and a plurality of teeth, wherein said teeth are located radially outward from said recesses.

19. The differential of claim 12, wherein said side gears are in driving engagement with two half shafts and wherein said half shafts and toe ends of said side pinions define a gap between them.

20. The differential of claim 12, wherein said recesses each have lubrication openings.
